(19) United States
(12) Patent Application Publication
(10) Pub. No.: US 2012/0194392 A1
(43) Pub. Date: Aug. 2, 2012

(54) ANTENNA AND INFORMATION TERMINAL APPARATUS

(75) Inventors: Kazuhiro INOUE, Tokyo (JP); Makoto HIGAKI, Kawasaki-shi (JP); Akiko YAMADA, Yokohama-shi (JP); Shuichi OBAYASHI, Yokohama-shi (JP)

(73) Assignee: Kabushiki Kaisha Toshiba, Minato-ku (JP)

(21) Appl. No.: 13/398,013

(22) Filed: Feb. 16, 2012

Related U.S. Application Data
(63) Continuation of application No. PCT/JP09/03953, filed on Aug. 19, 2009.

(51) Int. Cl. H01Q 1/38

(52) U.S. Cl. 343/700 MS

(57) ABSTRACT

This antenna includes: a ground conductor part; and a radiation conductor part that is disposed substantially parallel to and a predetermined distance apart from the ground conductor part and has a feeding point to which a high-frequency signal is fed, in which surface roughness of a predetermined region of at least one of the ground conductor part and the radiation conductor part is equal to or less than twice skin depth at an operating frequency.

### CROSS-REFERENCE TO RELATED APPLICATIONS

This application is a continuation of prior International Application No. PCT/JP2009/003953 filed on Aug. 19, 2009; the entire contents of all of which are incorporated herein by reference.

### FIELD

Embodiments described herein relate generally to an antenna capable of suppressing a reduction in radiation efficiency and being reduced in size.

### BACKGROUND

With the spread of a portable information apparatus, development of a small-sized antenna that is allowed to be housed in a small casing and has a wide operating frequency has been advanced. However, the size of an antenna, particularly the size of a radiator that radiates radio waves in the antenna is almost determined by a wavelength of a radio wave to be used. For example, in the case when the frequency of a radio wave to be used is relatively low and a wavelength of the radio wave is long, the size (or length) of a radiator is increased, and a space required to be taken between the radiator and ground is increased. When a reduction in size of an antenna is further advanced without considering the frequency of a radio wave to be used, thus reducing a space between its radiator and ground, radiation efficiency of radio waves is reduced.

For example, in the case when a dipole antenna is installed apart from a ground surface, when the height of the dipole antenna is reduced to let the dipole antenna approach the ground surface, radiation impedance is reduced to increase a high-frequency current to be applied to the antenna. As a result, loss in the antenna is increased and radiation efficiency is reduced.

As described above, in the conventional antenna, it has been difficult to reduce the antenna in size while maintaining radiation efficiency of the antenna.

An antenna according to one aspect of the embodiments includes: a ground conductor part; and a radiation conductor part that is disposed substantially parallel to and a predetermined distance apart from the ground conductor part and has a feeding point to which a high-frequency signal is fed, in which surface roughness of a predetermined region of at least one of the ground conductor part and the radiation conductor part is equal to or less than twice skin depth at an operating frequency.

According to the antenna of the embodiment, its size can be reduced without reducing radiation efficiency.

### BRIEF DESCRIPTION OF THE DRAWINGS

FIG. 1 is a perspective view illustrating an antenna in a first embodiment.

FIG. 2 is a cross-sectional view illustrating the antenna in the first embodiment.

FIG. 3 is a diagram illustrating a relationship between a distance between a radiation conductor and ground and radiation efficiency of the antenna.

FIG. 4 is a diagram illustrating a relationship between surface roughness of the radiation conductor and the radiation efficiency of the antenna.

FIG. 5 is a photograph showing one example of a cross section of the vicinity of a surface of the radiation conductor of the antenna in the first embodiment.

FIG. 6 is a photograph showing one example of a cross section of the vicinity of a surface of a radiation conductor of a conventional antenna.

FIG. 7 is a perspective view illustrating an antenna in a second embodiment.

FIG. 8 is a cross-sectional view illustrating the antenna in the second embodiment.

FIG. 9A is a view illustrating a state of a radiation conductor plane of the antenna in the second embodiment.

FIG. 9B is a view illustrating a state of an inner layer conductor plane of the antenna in the second embodiment.

FIG. 9C is a view illustrating a state of a ground conductor plane of the antenna in the second embodiment.

FIG. 10 is a perspective view illustrating an antenna in a third embodiment.

FIG. 11 is a cross-sectional view illustrating the antenna in the third embodiment.

FIG. 12A is a view illustrating a state of a radiation conductor plane of the antenna in the third embodiment.

FIG. 12B is a view illustrating a state of an inner layer conductor plane of the antenna in the third embodiment.

FIG. 12C is a view illustrating a state of a ground conductor plane of the antenna in the third embodiment.

FIG. 13 is a view illustrating an information terminal apparatus in a fourth embodiment.

### DETAILED DESCRIPTION

Hereinafter, embodiments will be explained in detail with reference to the drawings.

### First Embodiment

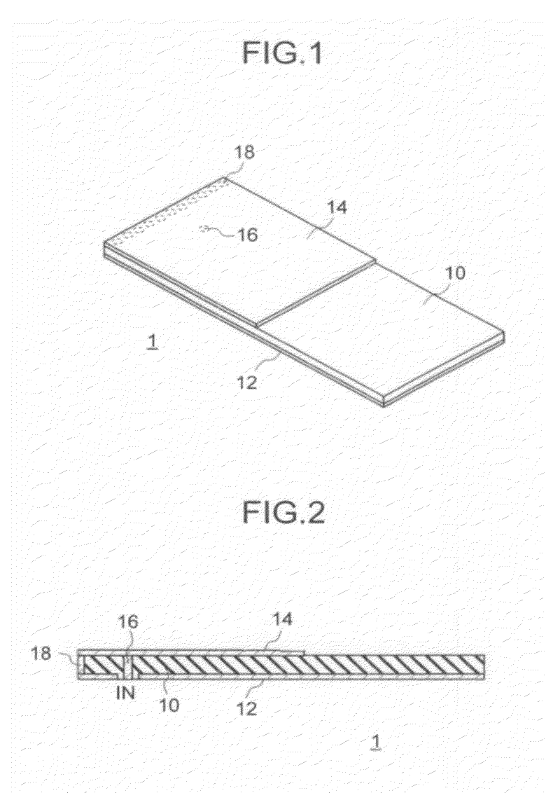

With reference to FIG. 1 and FIG. 2, a first embodiment will be explained. As illustrated in FIG. 1, an antenna 1 in this embodiment includes: a substrate 10; a ground conductor 12 formed on one principal surface of the substrate 10; a radiation conductor 14 formed on the other principal surface of the substrate 10; a feeding via hole 16 passing through the substrate 10; and short-circuit via holes 18 short-circuiting the ground conductor 12 and the radiation conductor 14 in a high-frequency manner. That is, the antenna 1 constitutes an inverted F-type antenna provided with the ground conductor 12 and the radiation conductor 14.

The substrate 10 is formed of a dielectric material, magnetic material or the like formed into a rectangular shape, for example. On the one principal surface of the substrate 10, the ground conductor 12 (a finite ground plane) is entirely formed, and on the other principal surface of the substrate 10, the radiation conductor 14 is formed in a manner to have a size large enough to resonate at an operating frequency and come into contact with one short side of the substrate 10. That is, the ground conductor 12 and the radiation conductor 14 are held on the substrate 10 substantially parallel to and apart from each other with a predetermined distance there between. As the ground conductor 12 and the radiation conductor 14, a conductive material such as, for example, copper, is used, which is formed into a thin film layer on each of the surfaces of the substrate 10.

On the side of the short side of the substrate 10 that the radiation conductor 14 is disposed close to, a plurality of the short-circuit via holes 18 are provided in a manner to pass through the substrate 10, and short-circuit the ground conductor 12 and the radiation conductor 14 in a high-frequency manner. Further, in the vicinity of the center of the radiation conductor 14, the feeding via hole 16 passing through the substrate 10 is provided. One end of the feeding via hole 16 is connected to the radiation conductor 14 (a feeding point), and the other end of the feeding via hole 16 is exposed from a circular hole provided in the ground conductor (a feeding terminal). Concretely, the hole formed in the ground conductor 12 is formed into a shape that surrounds the feeding via hole 16 concentrically, and the ground conductor 12 and the feeding via hole 16 are concentrically spaced at a predetermined interval there between and are not directly connected with each other. That is, in the vicinity of the feeding via hole 16, a state where the ground conductor 12 is removed is made, and an exposed part of the above substrate 10 and the feeding via hole 16 is used as a feeding terminal IN of the antenna 1.

The thickness of the substrate 10, namely a separation distance between the ground conductor 12 and the radiation conductor 14 can be made smaller than that of an ordinary inverted F-type antenna. However, as described previously, when the separation distance between the ground conductor 12 and the radiation conductor 14 is reduced, radiation impedance of the radiation conductor 14 is reduced, and thereby radiation efficiency deteriorates. Thus, the antenna 1 in the first embodiment is formed such that surface roughness of each of the ground conductor 12 and the radiation conductor 14 is made small, and thereby conductor loss is suppressed and improvement of the radiation efficiency is achieved. Concretely, as the substrate 10, a material capable of reducing the surface roughness of each of the ground conductor 12 and the radiation conductor 14 is selected, and the substrate 10 having the ground conductor 12 and the radiation conductor 14 formed thereon is manufactured. In the following explanation, “surface roughness” means “arithmetic mean roughness Ra” defined in Japan Industrial Standard (JIS B 0601-2001). Further, measurement of “surface roughness” in the following explanation is conducted by a stylus-type surface roughness measuring instrument.

Materials of the substrate 10, the ground conductor 12, and the radiation conductor 14 are selected from materials that exhibit good adhesiveness between the substrate 10 and the ground conductor 12 and good adhesiveness between the substrate 10 and the radiation conductor 14. This is because when materials that exhibit good adhesiveness are selected, by pressure bonding or the like, the substrate and a conductor layer can be bonded together with a smooth surface of the conductor being maintained, and the surface roughness can be made small. When the ground conductor 12 and the radiation conductor 14 are each formed of, for example, a copper thin film, for example, a liquid crystal polymer that has good adhesiveness to copper, or the like is selected for the substrate 10. Such selection makes it possible to bond the substrate and the conductor together with smooth bonding surfaces of the substrate and the conductor being maintained. As such a material of the substrate 10, in the case when copper is used for the ground conductor and the radiation conductor, besides the liquid crystal polymer, a fluorine-based resin such as polytetrafluoroethylene (PTFE), a polyimide, or the like is preferred. Incidentally, in terms of the selection of the material of the substrate 10, it is desirable to select not only the material having good adhesiveness to the conductor layer but also a material having good insulation performance or the like.

The preferred surface roughness of each of the ground conductor 12 and the radiation conductor 14 in the antenna in this embodiment varies according to the operating frequency of the antenna. In the case when the frequency of a radio wave to be used is set to f [Hz], the surface roughness of each of the ground conductor 12 and the radiation conductor 14 is set to h [m], conductivity is set to σ [S/m], permeability is set to μ [H/m] (copper: 4π10⁻⁷), and skin depth is set to δ [m] (=(2/ωμσ)^{1/2}; ω=2πf), the surface roughness such that a ratio h/δ of the surface roughness to the skin depth becomes equal to or less than two is desirably set. In other words, the surface roughness of the conductor is desirably set to be equal to or less than twice the skin depth at the operating frequency.

### Significance of Reducing the Surface Roughness

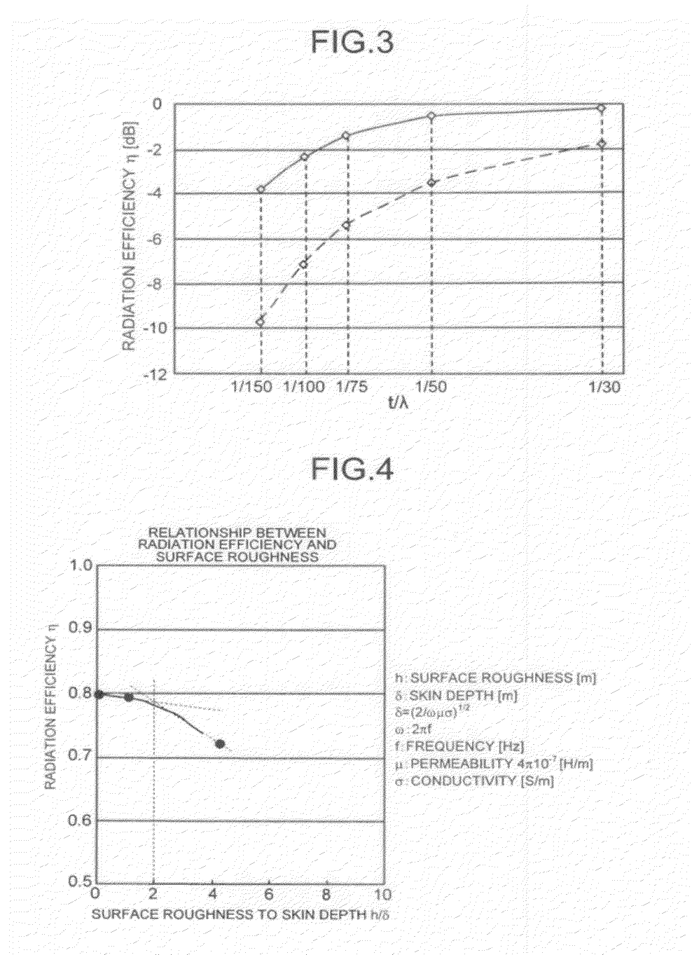

Here, with reference to FIG. 3 and FIG. 4, the significance that the surface roughness of the conductor layer is set to be equal to or less than twice the skin depth at the operating frequency in the first embodiment will be explained. FIG. 3 illustrates a relationship between the substrate thickness and the radiation efficiency of the inverted F-type antenna whose designed frequency is set to 2 GHz (a wavelength λ: 150 [mm]) and that is illustrated in FIG. 1 and FIG. 2. A solid line indicates a relationship between a ratio t/λ of a substrate thickness t to the wavelength λ and the radiation efficiency in the case of the surface roughness h being set to 1 [μm] (an example of a liquid crystal polymer substrate according to the first embodiment), and a dotted line indicates a relationship between the ratio t/λ of the substrate thickness t to the wavelength λ and the radiation efficiency in the case of the surface roughness of each of the ground conductor 12 and the radiation conductor 14 being set to 8 [μm] (an example of a conventional standard glass epoxy substrate).

As described previously, it has been known that in general, when the radiation conductor that radiates radio waves and the ground conductor are approached, the radiation efficiency is reduced, and FIG. 3 also indicates that the shorter the separation distance between the ground conductor 12 and the radiation conductor 14 becomes, the lower the radiation efficiency becomes. It is found from a graph in FIG. 3 in particular that when in a conventional antenna indicated by the dotted line, the ratio t/λ of a separation distance t between the ground conductor 12 and the radiation conductor 14 to the wavelength λ at the operating frequency falls below 1/50, the radiation efficiency is reduced rapidly. This is conceivably because as the radiation conductor 14 approaches the ground conductor 12, the radiation impedance of the radiation conductor 14 is reduced to increase feeding current, and thereby it becomes impossible to ignore the conductor loss due to the surface roughness.

The inventors have paid attention to the surface roughness of the conductor layer in order to suppress the reduction in the radiation efficiency caused by the conductor loss and the feeding current increased by reducing the distance between the ground conductor 12 and the radiation conductor 14. It has been known that in the case when a high-frequency current is applied to a conductor, the current intensively flows through a surface of the conductor by a skin effect. When surface roughness of the conductor is large, conductor loss is increased to thereby reduce radiation efficiency of an antenna. However, in the case when a conductor layer (for example, copper) is formed on a substrate in general, it has been conducted that surface roughness of the conductor layer is increased to some extent and adhesiveness of the conductor layer to the substrate is improved. Thus, in the first embodiment, as the material of the substrate 10, the material capable of reducing the surface roughness of the conductor layer, which is a dielectric polymer, or the like, is selected.

The characteristic indicated by the solid line in FIG. 3 is that as the material of the substrate 10, the liquid crystal polymer is employed, and the surface roughness is set to ⅛ compared with that of the conventional glass epoxy substrate. As indicated by the solid line in FIG. 3, when the surface roughness is reduced, the radiation efficiency of the antenna is improved. It is found that even though t/λ is equal to or less than 1/50 in particular, the reduction in the radiation efficiency is suppressed, and the radiation efficiency is improved by 2 to 6 [dB] compared with that of the conventional antenna.

### Consideration of the Concrete Surface Roughness

FIG. 4 illustrates a relationship between the ratio h/δ of the surface roughness to the skin depth and the radiation efficiency of the antenna. As illustrated in FIG. 4, it is indicated that when the surface roughness is increased with respect to the skin depth, the radiation efficiency is reduced. It can be read that when the value of h/δ exceeds two in particular, the tendency to reduce the radiation efficiency increases. Accordingly, the value of h/δ is desirably set to be equal to or less than two in order to suppress the reduction in the radiation efficiency.

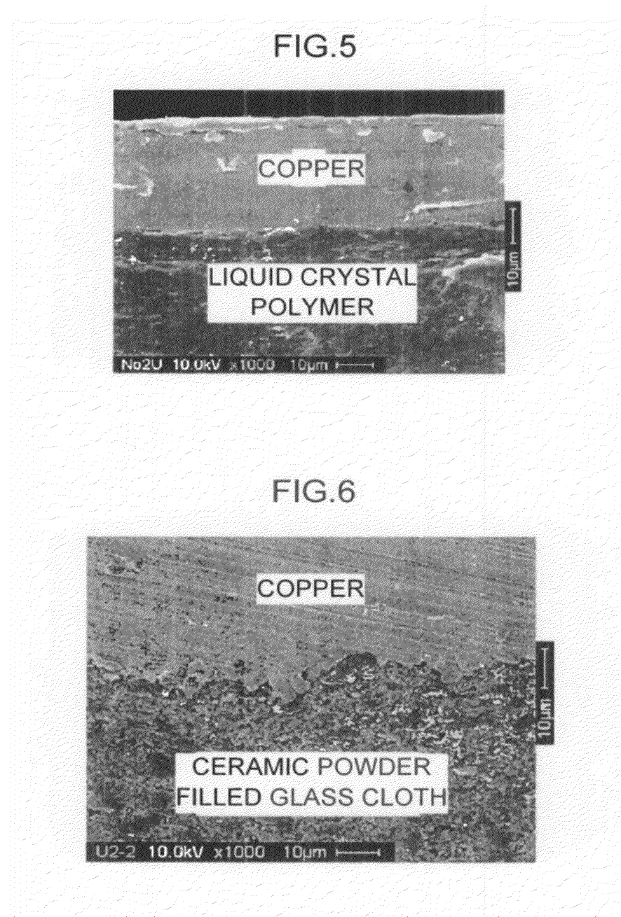

FIG. 5 shows a state of an interface of the liquid crystal polymer substrate with the conductor layer as a concrete example of the substrate 10 in the first embodiment, and FIG. 6 shows a state of an interface of a ceramic powder filled glass cloth substrate with the conductor layer as an example of the conventional substrate. As shown in FIG. 5, it is found that the surface roughness of the conductor layer on the liquid crystal polymer substrate is approximately 2 [μm]. On the other hand, as shown in FIG. 6, it is found that surface roughness of the conductor layer on the conventional substrate is approximately 10 [μm]. When copper is employed as the conductor layer, the skin depth δ at 2 GHz (wavelength λ: 150 mm) becomes 1.478 [μm], and similarly, the skin depth δ at 1 GHz (wavelength λ: 300 mm) becomes 2.09 [μm]. Accordingly, if the liquid crystal polymer substrate shown in FIG. 5 is employed, h/δ becomes equal to or less than two, so that the reduction in the radiation efficiency is allowed to be suppressed more than the conventional substrate.

### Method of Reducing the Surface Roughness

As a method of reducing the surface roughness of the conductor layer in the first embodiment, an example where the substrate is manufactured, with the substrate material having good adhesiveness to the conductor layer material, has been explained, but the present invention is not limited to this. For example, even though a metal having low roughness on an interface with the substrate 10 is used as the material of each of the ground conductor 12 and the radiation conductor 14, a similar effect can be obtained. Concretely, it is conceivable that a metal foil having low roughness is formed into an appropriate shape, and an adhesive such that its variation in thickness becomes equal to or less than twice the skin depth δ at the operating frequency of the antenna is applied to the metal foil, and the metal foil having the adhesive applied thereto is applied to a dielectric or magnetic substance having low roughness similarly. In the above case, the shape of the dielectric or magnetic substance may be one developed into a two-dimensional plane shape, or may also be one having a three-dimensional shape.

Further, it is also conceivable that in an apparatus having an antenna to be mounted thereon, a portion formed of a metal or conductor is manufactured such that its variation in thickness becomes equal to or less than twice the skin depth δ at the operating frequency of the antenna, and in the above portion, a feeding point for applying a high-frequency current thereto is provided, and the above portion is used as a radiation conductor of the antenna transmitting and receiving a high- frequency signal. In the above case, it goes without saying that the portion formed of the metal or conductor may be one developed into a two-dimensional plane shape, or may also be one having a three-dimensional shape.

Similarly, it is also conceivable that in an apparatus having an antenna to be mounted thereon, a portion formed of a resin, dielectric, or magnetic substance is manufactured such that its variation in thickness becomes equal to or less than twice the skin depth δ at the operating frequency of the antenna, and to the above portion, an adhesive such that its variation in thickness becomes equal to or less than twice the skin depth δ at the operating frequency of the antenna is applied, and to the above portion having the adhesive applied thereto, a conductor corresponding to a radiator in which a metal foil having low roughness is used is applied. Similarly, the portion formed of the resin, dielectric, or magnetic substance may be one developed into a two-dimensional plane shape, or may also be one having a three-dimensional shape.

Further, in the above-described explanation, the case where the conductor layer is applied to the substrate with the adhesive has been described, but it is also conceivable that for the conductor itself, metal plating such that its variation in thickness becomes equal to or less than twice the skin depth δ at the operating frequency of the antenna is used, and the antenna is constituted, or the conductor layer is applied to the substrate with an adhesive tape.

### Experimental Example

The antenna having the constitution illustrated in FIG. 1 and FIG. 2 is manufactured, and an effect obtained by reducing the surface roughness of the conductor layer is considered. When the operating frequency is set to 1 GHz (an operating wavelength: 300 mm), the skin depth δ in the case when copper is used for the material of each of the ground conductor 12 and the radiation conductor 14 becomes 2.09 [μm]. When the distance between the ground conductor 12 and the radiation conductor 14 (the thickness t of the substrate 10) is set to 1 [mm], the value of t/λ becomes about 1/300 of the operating wavelength in a free space corresponding to the operating frequency of the antenna. Note that dielectric loss of the substrate 10 can be ignored.

In the case when the conventional glass epoxy substrate is used to manufacture the antenna, the surface roughness h of each of the ground conductor 12 and the radiation conductor 14 becomes about 7 to 8 [μm]. At this time, the ratio h/δ of the surface roughness to the skin depth becomes 4.0, and the radiation efficiency becomes about −5.8 [dB].

In the case when the liquid crystal polymer substrate is used to manufacture the antenna based on the first embodiment, the surface roughness h becomes about 2 [μm] and the surface roughness of each of the ground conductor 12 and the radiation conductor 14 becomes about ¼ compared with that of the ordinary glass epoxy substrate or the like. At this time, the ratio h/δ of the surface roughness to the skin depth becomes 0.96, and the radiation efficiency becomes about −2.2 [dB]. That is, when the surface roughness of the conductor layer is set to be equal to or less than twice the skin depth at the operating frequency, which is ¼ of that in a conventional example, the radiation efficiency is improved by 3.6 [dB].

### Second Embodiment

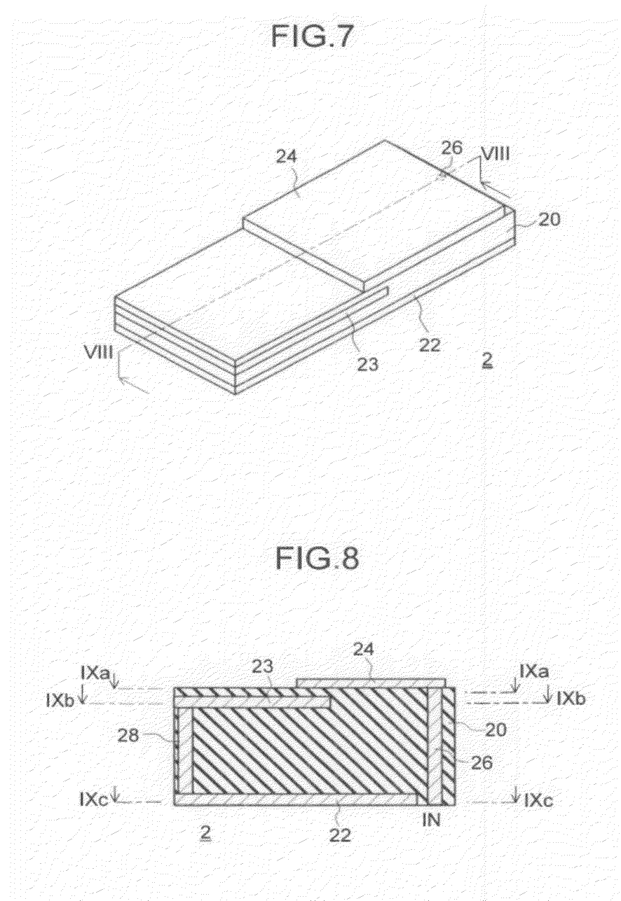

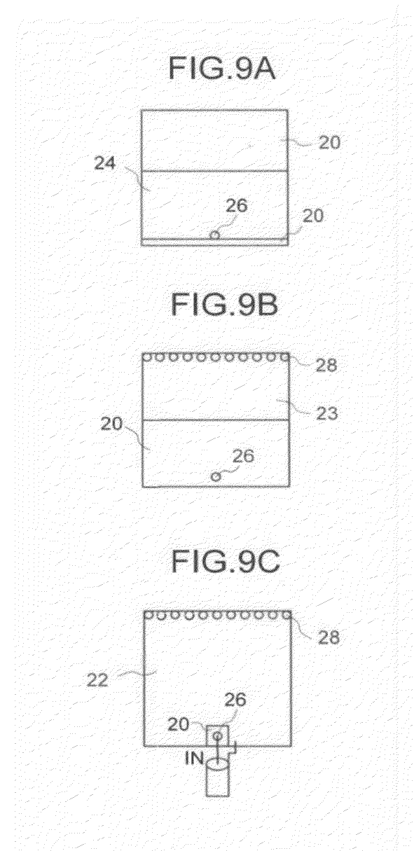

Subsequently, with reference to FIG. 7, FIG. 8, and FIG. 9A to FIG. 9C, an antenna in a second embodiment of the present invention will be explained. An antenna 2 according to the second embodiment is one in which an inner layer conductor connected to a ground conductor is added to the constitution of the antenna in the first embodiment.

As illustrated in FIG. 7 and FIG. 8, the antenna 2 in this embodiment includes: a substrate 20; a ground conductor 22 formed on one principal surface of the substrate 20; a radiation conductor 24 formed on the other principal surface of the substrate 20; and a feeding via hole 26 passing through the substrate 20. Such a constitution is common to that of the antenna 1 in the first embodiment. The antenna 2 in this embodiment is further provided with an inner layer conductor 23 that is an inner layer inside the substrate 20 and is provided at a position close to the radiation conductor 24; and short-circuit via holes 28 short-circuiting the ground conductor 22 and the inner layer conductor 23 in a high-frequency manner. In the following explanation, the explanation of the constitution common to that of the first embodiment is omitted.

The radiation conductor 24 is formed close to one short side of the substrate 20, and the feeding via hole 26 passes through the substrate 20 in the vicinity of the short side of the substrate 20 of the side that the radiation conductor 24 is placed close to. Thus, a feeding terminal IN is provided in the vicinity of the short side of the side that the radiation conductor 24 is placed close to. The inner layer conductor 23 is formed inside the substrate 20 close to the other short side of the substrate 20 so as to slightly overlap the radiation conductor 24 in a plane direction of the substrate 20. The ground conductor 22, the inner layer conductor 23, and the radiation conductor 24 are formed substantially parallel to one another. The inner layer conductor 23 and the ground conductor 22 are short-circuited by the short-circuit via holes 28 on the side of the other short side of the substrate 20. That is, in the antenna 2 in this embodiment, the feeding via hole is disposed in the vicinity of a short side of the radiation conductor, and the short-circuit via holes are disposed in the vicinity of the short side of the substrate 20 facing the side where the feeding via hole is disposed.

FIG. 9A to FIG. 9C illustrate a cross section of the antenna 2 taken along a line IXa-IXa in a cross-sectional view in FIG. 8 (a radiation conductor plane), across section of the antenna 2 taken along a line IXb-IXb in the cross-sectional view in FIG. 8 (an inner layer conductor plane), and a cross section of the antenna 2 taken along a line IXc-IXc in the cross-sectional view in FIG. 8 (a ground conductor plane) respectively. As illustrated in FIG. 9A to FIG. 9C, the radiation conductor 24 is formed at a position close to the one short side of the substrate 20, and the feeding via hole 26 is formed in the vicinity of the short side of the substrate 20 of the side that the radiation conductor 24 is placed close to. The feeding via hole 26 passes through the substrate 20 to be exposed to the outside at the feeding terminal IN. The ground conductor 22 is formed over the principal surface of the substrate 20 that faces the radiation conductor 24, and a plurality of the short-circuit via holes 28 are formed in the short side facing the short side of the substrate 20 of the side that the feeding via hole 26 is exposed to. The short-circuit via holes 28 are connected to the vicinity of one side of the inner layer conductor 23, and the other side of the inner layer conductor 23 slightly overlaps a side of the radiation conductor 24 in a principal surface direction of the substrate 20.

The constitution of the ground conductor 22 and the inner layer conductor 23 in the antenna 2 according to the second embodiment serves to allow the antenna to be low profile while maintaining a wide operating frequency band (to reduce a distance between the radiation conductor and the ground conductor). Such a technique has been known as an artificial magnetic conductor (AMC) substrate. On the AMC substrate, with a device of an electrical structure, a perfect magnetic conductor (PMC) is artificially fabricated, namely a characteristic in which incident electromagnetic waves are reflected in phase is artificially provided, so that even though the radiation conductor and the ground conductor are approached, the antenna can be operated over a wide frequency band. As the AMC substrate, a mushroom-type EBG substrate or the like is well known in particular. By paying attention to the above characteristic of in-phase reflection of incident electromagnetic waves, an aperiodic small-sized structure from which unit cells of a periodic structure forming the EBG substrate are extracted, (which will be called a metamaterial structure below), is devised, and making the antenna low profile is achieved over a wide band relatively.

As for the above aperiodic metamaterial structure, a problem of increase in area due to a reduction in thickness of the EBG substrate is solved, and as for a low profile antenna to be fabricated by a further reduction in thickness of the metamaterial structure, its lower profile is achieved than a conventional planar antenna. However, as a result that the distance between the radiation conductor and the ground conductor is reduced, conductor loss determined by current and conductivity tends to increase.

Thus, surface roughness of each of the ground conductor 22, the inner layer conductor 23, and the radiation conductor 24 is set to be equal to or less than twice skin depth at an operating frequency, similarly to the first embodiment. That is, also in the second embodiment, the substrate 20 is desirably formed of a material capable of reducing the surface roughness of each of the ground conductor 22, the inner layer conductor 23, and the radiation conductor 24. Further, as a material of each of the ground conductor 22, the inner layer conductor 23, and the radiation conductor 24, by using a metal having low roughness on an interface with the substrate 20, a substrate can also be formed. Besides, by a method similar to that in the first embodiment, the surface roughness of each of the ground conductor 22, the inner layer conductor 23, and the radiation conductor 24 is set such that the value of h/δ becomes equal to or less than two, and thereby a reduction in radiation efficiency of the antenna 2 can be suppressed.

Further, the antenna 2 in this embodiment has the inner layer conductor interposed between the ground conductor and the radiation conductor, and thus is excellent in an isolation characteristic between the ground conductor and the radiation conductor. This allows the antenna to be installed in an information terminal having a lot of noise sources, particularly at the rear of a liquid crystal display unit, or in the vicinity of another electronic component.

### Experimental Example

The antenna having the constitution illustrated in FIG. 7, FIG. 8, and FIG. 9A to FIG. 9C is set as an example, and the desirable surface roughness is considered based on measured values. When the operating frequency is set to 2 GHz (an operating wavelength: 150 mm), the skin depth δ in the case when copper is used for the material of each of the ground conductor 22, the inner layer conductor 23, and the radiation conductor 24 becomes 1.478 [μm]. When the distance between the ground conductor 22 and the radiation conductor 24 (a thickness t of the substrate 20) is set to 1 [mm], the value of t/λ becomes about 1/150 of the operating wavelength in a free space corresponding to the operating frequency of the antenna. Note that dielectric loss of the substrate 20 can be ignored.

When it is assumed that the surface roughness h is zero, namely conductivity of copper is applied as it is, the radiation efficiency is reduced to about 80% because the distance between the ground conductor 22 and the radiation conductor 24 is reduced.

In the case when a conventional glass epoxy substrate is used to manufacture the antenna, the surface roughness h of each of the ground conductor 22, the inner layer conductor 23, and the radiation conductor 24 becomes about 7 to 8 [μm]. At this time, the ratio h/δ of the surface roughness to the skin depth becomes 4.4, and the radiation efficiency deteriorates to about 72%.

In the case when a liquid crystal polymer substrate is used to manufacture the antenna based on the second embodiment, the surface roughness h becomes about 2 [μm] and the surface roughness of each of the ground conductor 22, the inner layer conductor 23, and the radiation conductor 24 is about ¼ compared with that of the ordinary glass epoxy substrate or the like. At this time, the ratio h/δ of the surface roughness to the skin depth becomes about 1.3, and the radiation efficiency becomes about 79%. That is, it is found that by reducing surface roughness of a conductor layer, the reduction in the radiation efficiency is suppressed.

### Third Embodiment

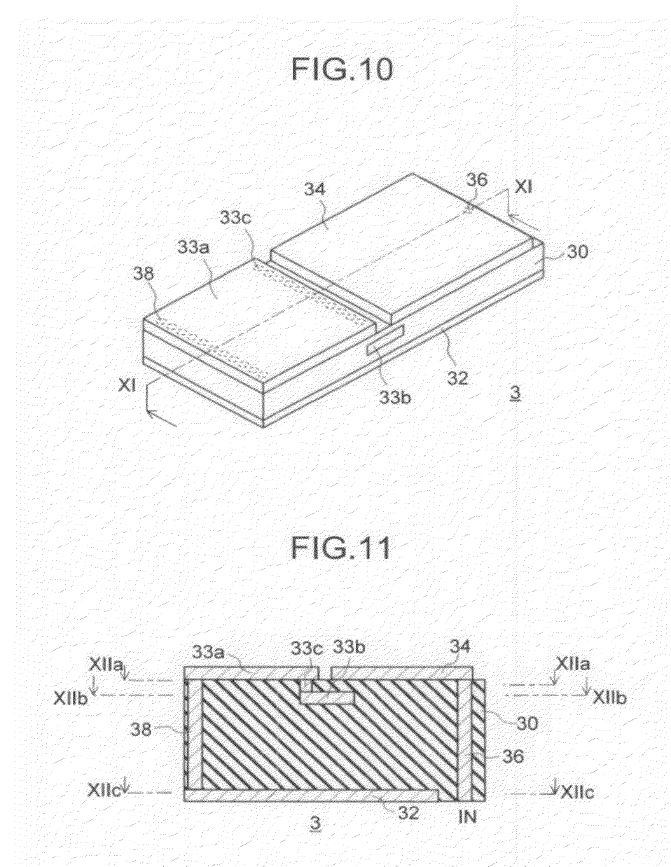

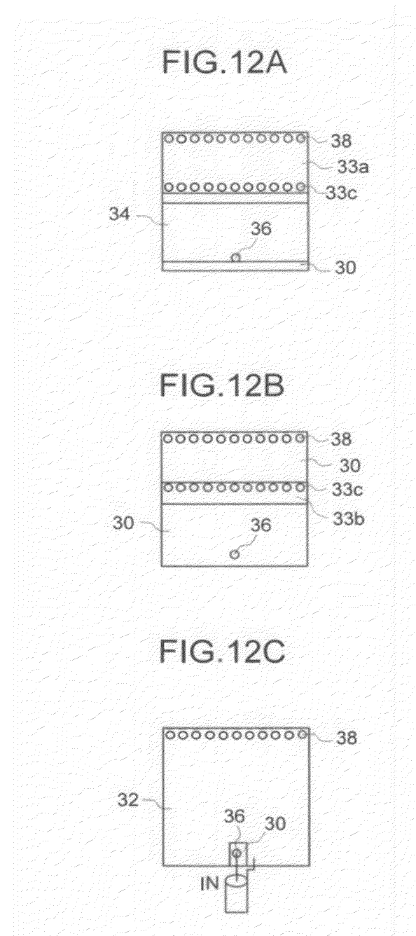

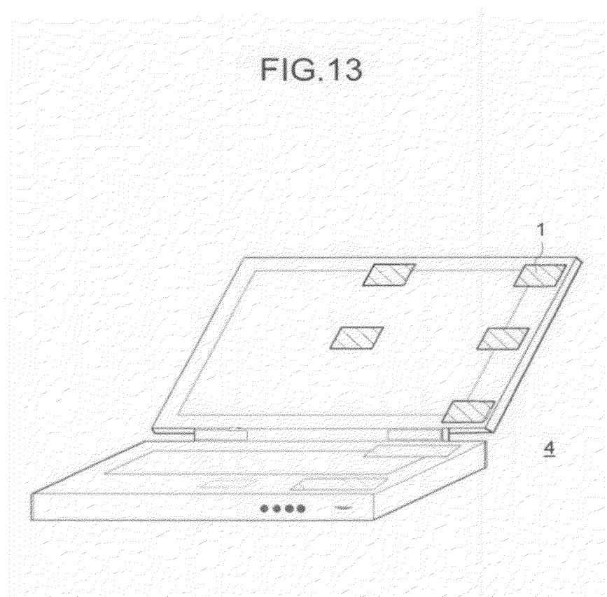

Subsequently, with reference to FIG. 10, FIG. 11, and FIG. 12A to FIG. 12C, an antenna according to a third embodiment of the present invention will be explained. An antenna 3 according to the third embodiment is one in which an inner layer conductor connected to a ground conductor is added to the constitution of the antenna according to the second embodiment.

As illustrated in FIG. 10 and FIG. 11, the antenna 3 in this embodiment includes: a substrate 30; a ground conductor 32 formed on one principal surface of the substrate 30; a radiation conductor 34 formed on the other principal surface of the substrate 30; and a feeding via hole 36 passing through the substrate 30. Such a constitution is common to that of the antenna 2 in the second embodiment. The antenna 3 in this embodiment is further provided with an outer layer conductor 33a that is formed on the same surface as the radiation conductor 34 and is formed close to a short side facing a short side of the substrate 30 where the radiation conductor 34 is formed, an inner layer conductor 33b that is an inner layer inside the substrate 30 and is provided at a position close to the radiation conductor 34, inner-layer short-circuit via holes 33c electrically connecting the outer layer conductor 33a and the inner layer conductor 33b, and short-circuit via holes 38 short-circuiting the outer layer conductor 33a and the ground conductor 32. In the following explanation, the explanation of the constitution common to that of the first and second embodiments is omitted. The antenna 3 according to the third embodiment is one in which the inner layer conductor 23 in the antenna 2 according to the second embodiment is replaced with the outer layer conductor 33a, the inner layer conductor 33b, and the inner-layer short-circuit via holes 33c.

The radiation conductor 34 is formed close to the one short side of the substrate 30, and the feeding via hole 36 passes through the substrate 30 in the vicinity of the short side of the substrate 30 of the side that the radiation conductor 34 is placed close to. Thus, a feeding terminal IN is provided in the vicinity of the short side of the substrate 30 of the side that the radiation conductor 34 is placed close to. The outer layer conductor 33a is formed on the same surface as the radiation conductor 34 close to the short side facing the short side of the substrate 30 that the radiation conductor 34 is placed close to. The inner layer conductor 33b is formed inside the substrate 30 so as to slightly overlap the outer layer conductor 33a and the radiation conductor 34 in a principal surface direction of the substrate 30. The ground conductor 32, the outer layer conductor 33a, the radiation conductor 34, and the inner layer conductor 33b are formed substantially parallel to one another. The outer layer conductor 33a and the ground conductor 32 are short-circuited by the short-circuit via holes 38 on the side of the other short side of the substrate 30. That is, in the antenna 3 in this embodiment, the feeding via hole is disposed in the vicinity of a short side of the radiation conductor, and the short-circuit via holes are disposed in the vicinity of the short side of the substrate 30 facing the side where the feeding via hole is disposed. Further, an end portion of the outer layer conductor 33a and an end portion of the inner layer conductor 33b are electrically connected with each other by the inner-layer short-circuit via holes 33c.

FIG. 12A to FIG. 12C illustrate a cross section of the antenna 3 taken along a line XIIa-XIIa in a cross-sectional view in FIG. 11 (a radiation conductor plane), a cross section of the antenna 3 taken along a line XIIb-XIIb in the cross-sectional view in FIG. 11 (an inner layer conductor plane), and a cross section of the antenna 3 taken along a line XIIc-XIIc in the cross-sectional view in FIG. 11 (a ground conductor plane) respectively. As illustrated in FIG. 12A to FIG. 12C, the radiation conductor 34 is formed at a position close to the one short side of the substrate 30, and the feeding via hole 36 is connected to the side that the radiation conductor 34 is placed close to (a feeding point). The feeding via hole 36 passes through the substrate 30 to be exposed to the outside at the feeding terminal IN. The ground conductor 32 is formed over the principal surface of the substrate 30 that faces the radiation conductor 34, and a plurality of the short-circuit via holes 38 are connected to the short side facing the short side of the substrate 30 of the side that the feeding via hole 36 is exposed to. The short-circuit via holes 38 are connected to the vicinity of one side of the outer layer conductor 33a, and the other side of the outer layer conductor 33a is connected to one side of the inner layer conductor 33b via the inner-layer short-circuit via holes 33c.

The constitution of the ground conductor 32, the outer layer conductor 33a, and the inner layer conductor 33b in the antenna 3 according to the third embodiment serves to allow the antenna to be low profile while maintaining a wide operating frequency band (to reduce a distance between the radiation conductor and the ground conductor) similarly to the second embodiment. Also in the antenna 3 according to the third embodiment, as a result that the distance between the radiation conductor and the ground conductor is reduced, conductor loss determined by current and conductivity tends to increase.

Thus, surface roughness of each of the ground conductor 32, the outer layer conductor 33a, the inner layer conductor 33b, and the radiation conductor 34 is set to be equal to or less than twice skin depth at an operating frequency, similarly to the second embodiment. Similarly to the second embodiment, also in the third embodiment, the substrate 30 is desirably formed of a material capable of reducing the surface roughness of each of the ground conductor 32, the outer layer conductor 33a, the inner layer conductor 33b, and the radiation conductor 34. As a material of each of the ground conductor 32, the outer layer conductor 33a, the inner layer conductor 33b, and the radiation conductor 34, by using a metal having low roughness on an interface with the substrate 30, a substrate can also be formed. Besides, by a method similar to that in the second embodiment, the surface roughness of each of the ground conductor 32, the outer layer conductor 33a, the inner layer conductor 33b, and the radiation conductor 34 is set such that the value of h/δ becomes equal to or less than two, and thereby a reduction in radiation efficiency of the antenna 3 can be suppressed.

Incidentally, the antenna 3 according to the third embodiment can apply a wide operating frequency band with the same substrate thickness compared with the antenna according to the first or second embodiment. Further, similarly to the antenna according to the second embodiment, the antenna 3 is excellent in an isolation characteristic between the ground conductor and the radiation conductor. This allows the antenna to be installed in an information terminal having a lot of noise sources, particularly at the rear of a liquid crystal display unit, or in the vicinity of another electronic component.

Incidentally, in the antenna according to the first, second, or third embodiment, when the surface roughness h exceeds twice the skin depth δ at the operating frequency of the antenna, the radiation efficiency deteriorates rapidly. This means that at the operating frequency of the antenna, the reduction in the radiation efficiency is suppressed, but at frequencies other than the operating frequency, the radiation efficiency is reduced. That is, the antenna according to the first, second, or third embodiment operates as a filter that attenuates frequency signals outside the operating frequency band of the antenna, so that interference signals outside a desired frequency band can be reduced.

### Fourth Embodiment

With reference to FIG. 13, an information terminal in a fourth embodiment will be explained. An information terminal 4 in this embodiment is one in which the antenna according to the first, second or third embodiment is housed therein to enable communication with the outside. As described previously, in the antenna according to the first, second or third embodiment, the distance between the radiator and the ground can be reduced, compared with a normal sized antenna depending on its operating frequency, so that the entire antenna can be made low profile (reduced in thickness). Accordingly, the antenna can be easily provided in the vicinity of a liquid crystal display unit or a keyboard of an information terminal having a thin thickness.

It should be noted that the present invention is not limited to the above-described embodiments as they are, and in an implementation stage, it can be embodied by modifying components thereof within a range not departing from the spirit of the invention.

In the above-described embodiments, the explanation has been conducted based on an example where the surface roughness of each of the surfaces of all the conductor layers is reduced, but the present invention is not limited to this. For example, as has been known in Ohm's law or the like, power loss is represented by a product of a square of current and resistivity (a reciprocal of conductivity) in a predetermined place. Thus, in the case when a current concentration place in the radiation conductor or the ground conductor is found in advance by analysis or measurement, the conductor layer having small surface roughness is disposed only at the portion where current is concentrated, and thereby the radiation efficiency can be similarly improved.

Further, in the above-described embodiments, the operation has been explained with a focus on the inverted F-type antenna, but the present invention is also not limited to this. As long as an antenna is provided with the ground conductor and the radiation conductor, when the ground conductor and the radiation conductor are approached, a place through which a large amount of current flows occurs. In such a case, the surface roughness of each of the conductor layers is formed to be reduced, and thereby the radiation efficiency can be improved.

Furthermore, in the above-described embodiments, the explanation has been conducted based on an example where the surface roughness of each of the ground conductor, the outer layer conductor, the inner layer conductor, and the radiation conductor is reduced, but the present invention is also not limited to this. As long as the surface roughness of at least one of these conductors (layers) is formed to be reduced, a certain effect can be obtained. In the above case, it goes without saying that an effect of improving the radiation efficiency is more increased when the surface roughness of each of all the conductor layers is reduced than when the surface roughness of only one portion of the conductor layers is reduced.

Embodiments described herein can be applied not only to radio communication represented by a radio terminal such as a mobile phone or a PC with a wireless LAN and an antenna for terrestrial digital reception but also to an antenna for radar and the like. Particularly, it is suitable for an antenna to be disposed on a surface of a movable body required to be reduced in thickness.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna, comprising:
a ground conductor part; and
a radiation conductor part disposed substantially parallel to and a predetermined distance apart from the ground conductor part, the radiation conductor part having a feeding point to which a high-frequency signal is fed,
wherein a surface roughness of a predetermined region of at least one of the ground conductor part and the radiation conductor part is equal to or less than twice skin depth at an operating frequency.

2. The antenna according to claim 1,
wherein the radiation conductor part is disposed a distance that is equal to or less than 1/50 of an operating wavelength in a free space of the operating frequency apart from the ground conductor part.

3. The antenna according to claim 1,
wherein a surface roughness of an entire surface of at least one of the ground conductor part and the radiation conductor part is equal to or less than twice skin depth at an operating frequency.

4. The antenna according to claim 1, further comprising:
a substrate made of a dielectric material; and
a via hole configured to pass through the substrate and to short-circuit the ground conductor part and the radiation conductor part,
wherein the ground conductor part is formed on one principal surface of the substrate, and the radiation conductor part is formed on the other principal surface of the substrate.

5. The antenna according to claim 4,
wherein the substrate is made of one of a liquid crystal polymer, fluorine-based resin, and polyimide.

6. An information terminal apparatus having the antenna according to claim 1 housed therein.
